(19) United States
(12) Patent Application Publication
(10) Pub. No.: US 2013/0251506 A1
(43) Pub. Date: Sep. 26, 2013

(54) WIND TURBINE ELECTRICITY GENERATING APPARATUS

(71) Applicant: David-Yu Chu, Taipei City (TW)

(72) Inventor: David-Yu Chu, Taipei City (TW)

(21) Appl. No.: 13/427,392

(22) Filed: Mar. 22, 2012

(51) Int. Cl. F03D 7/02

(52) U.S. Cl. 415/4.3

(57) ABSTRACT

A wind turbine electricity generating apparatus includes a wind collecting unit having a funnel-shaped wall and terminating at inlet and internal-port ends to define an air channel for passage of a main stream of incoming wind, and a rotor unit having a rotor rotated by united wind streams dashing into a rotor housing so as to generate electricity by a generator. A wind-stream accelerating unit disposed outwardly of the funnel-shaped wall to speed up the velocity of a side stream taken up through an uptake port such that an accelerated side stream of wind is delivered into the air channel and entrained in the main stream to induce a negative pressure, thereby forming the united stream with an increased velocity.

### BACKGROUND OF THE INVENTION

1. Field of the Invention

This invention relates to a wind turbine electricity generating apparatus, more particularly to a wind turbine electricity generating apparatus that includes a wind collecting device for accelerating incoming wind to propel rotation of a rotor.

2. Description of the Related Art

Wind energy is one of the available forms of natural energy, such as solar energy, hydro (tidal) energy, thermal energy, etc., and can be utilized to generate electricity. Conventional systems for using wind energy to generate electricity have disadvantages that the systems can not be operated in an almost windless situation. Moreover, stable electricity generation can not be achieved if the conventional systems are utilized in a region that has wind from various directions. Furthermore, the systems may malfunction if the wind is too strong.

### SUMMARY OF THE INVENTION

An object of the present invention is to provide a wind turbine electricity generating apparatus which can overcome the aforementioned drawbacks.

According to this invention, the wind turbine electricity generating apparatus includes a wind collecting unit, a rotor unit, a primary re-entry conduit, and a primary wind-stream accelerating unit.

The wind collecting unit has an inlet end and an internal-port end which are opposite to each other in a lengthwise direction, and which respectively define a wind inlet and an internal port, and a funnel-shaped wall which extends between the inlet and internal-port ends and which defines an air channel for passage of a main stream of incoming wind from the wind inlet to the internal port. The air channel has distal and proximate regions relative to the internal port, and is configured to converge from the distal region toward the proximate region. The funnel-shaped wall has uptake and re-entry ports extending therethrough to communicate with the distal and proximate regions, respectively.

The rotor unit includes a rotor housing and a rotor. The rotor housing has a surrounding wall which surrounds a rotary axis that is perpendicular to the lengthwise direction, and which defines a rotor receiving chamber. The surrounding wall is connected with the internal-port end, and has an entry port in spatial communication with the internal port so as to permit entry of united wind streams into the rotor receiving chamber. The rotor includes a rotary shaft rotatably mounted on the rotor housing in the rotor receiving chamber about the rotary axis, and a plurality of vanes which extend radially from the rotary shaft and which are angularly displaced from one another about the rotary axis. Each of the vanes has a leading vane face which confronts the united wind streams and is driven thereby so as to rotate the rotary shaft.

The primary re-entry conduit is disposed in the proximate region downstream of the re-entry port and extends to terminate at a nozzle end which is located immediately upstream of the internal port.

The primary wind-stream accelerating unit is disposed outwardly of the funnel-shaped wall between the first uptake and re-entry ports to speed up the velocity of a side stream of wind taken up through the uptake port such that a accelerated side stream of wind is delivered out of the nozzle end to be entrained in the main stream so as to induce a negative pressure, thereby forming the united stream with an increased velocity before dashing through the entry port into the rotor receiving chamber.

Even in an almost windless case, an increased wind velocity can be generated at the internal port to enable continued operation of the rotor.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic sectional view of the first embodiment of a wind turbine electricity generating apparatus according to this invention;

FIG. 2 is a schematic view showing a funnel-shaped wall of a wind collecting unit of the first embodiment;

FIG. 3 is a cross-sectional view showing a tubular zone of the funnel-shaped wall;

FIG. 4 is an enlarged view of an encircled portion (B) in FIG. 1;

FIG. 5 is a cross-sectional view showing an airflow rectifying member of the first embodiment;

FIG. 6 is a schematic view showing one form of an inflow regulating valve of the first embodiment;

FIG. 7 is a schematic view showing another form of the inflow regulating valve;

FIG. 8 is a schematic view showing a plurality of re-entry conduits extending into a rotor receiving chamber of a rotor housing;

FIG. 9 is a schematic view showing a rotor unit of the first embodiment;

FIG. 10 is an enlarged view of an encircled portion (A) in FIG. 1;

FIG. 11 is a schematic view showing a main stream of incoming wind of the wind collecting unit;

FIG. 12 is a fragmentary sectional view showing a gap reducing unit of the first embodiment;

FIG. 13 is a schematic view showing a moisture removing unit of the first embodiment;

FIG. 14 is a schematic side view of the second embodiment according to this invention;

FIG. 15 is a schematic side view of the third embodiment according to this invention;

FIG. 16 is a schematic side view showing the wind collecting unit in another tilted position of the second embodiment;

FIG. 17 is a schematic view of the fourth embodiment according to this invention;

FIG. 18 is a top view of FIG. 17;

FIG. 19 is a sectional schematic view of the fifth embodiment according to this invention; and

FIG. 20 is a schematic view showing an angled roof mounted on a wind duct.

### DETAILED DESCRIPTION OF THE PREFERRED EMBODIMENTS

Before the present invention is described in greater detail, it should be noted that same reference numerals have been used to denote like elements throughout the specification.

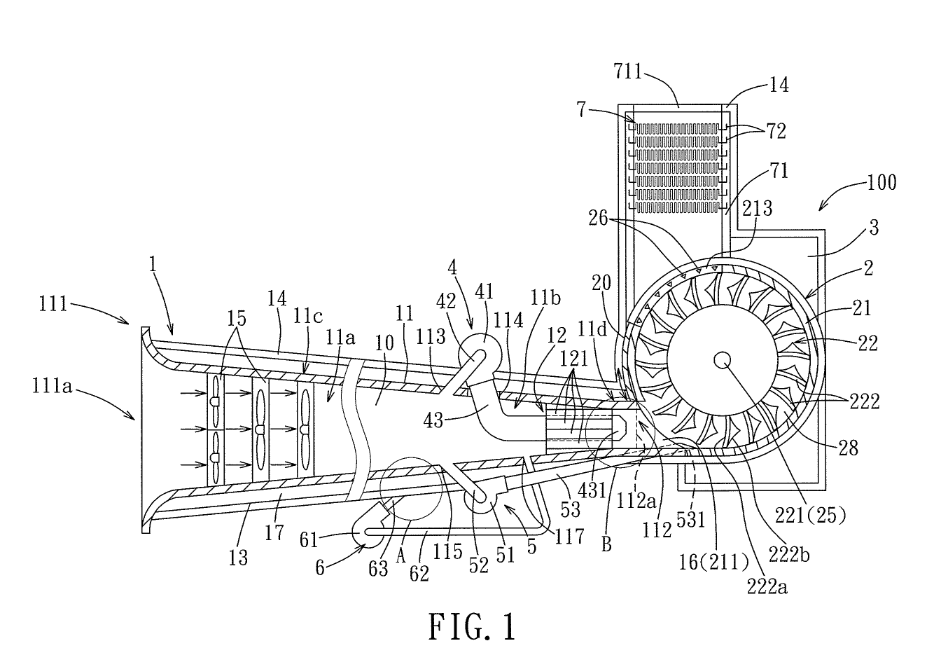

Referring to FIG. 1, the first embodiment of a wind turbine electricity generating apparatus according to the present invention is shown to comprise a wind turbine electricity generating device 100. The device 100 includes a wind collecting unit 1, a rotor unit 2, a generator 3, and a primary wind-stream accelerating unit 4. Incoming wind flows into the wind collecting unit 1 to rotate the rotor unit 2 so as to permit the generator 3 to convert the rotation of the rotor unit 2 into electricity.

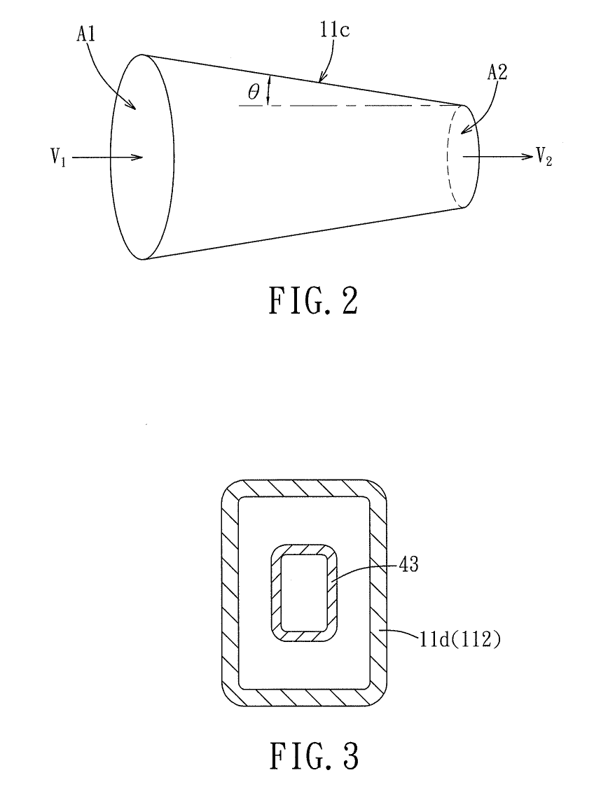

The wind collecting unit 1 has an inlet end 111 and an internal-port end 112 which are opposite to each other in a lengthwise direction, and which respectively define a wind inlet (111a) and an internal port (112a), and a funnel-shaped wall 11 which extends between the inlet and internal-port ends 111, 112 and which defines an air channel 10 for passage of a main stream of incoming wind from the wind inlet (111a) to the internal port (112a). The air channel 10 has distal and proximate regions (11a, 11b) relative to the internal port (112a), and is configured to converge from the distal region (11a) toward the proximate region (11b). Preferably, the funnel-shaped wall 11 has a conical zone (11c) which is converged from the inlet end 111 by a taper angle (θ) of about 10 degrees, as shown in FIG. 2, and a rectangular tubular zone (11d) which is dimensioned for evenly interconnecting the conical zone (11c) and the internal-port end 112, as shown in FIG. 3. The sectional areas (A1, A2) of the wind inlet (111a) and the internal port (112a) are dimensioned about 3 to 5 times in area ratio thereof. Hence, based on the equation of fluid flow: A₁V₁=A₂V₂, for example, even in an almost windless case, i.e., in a small wind velocity, with such configuration of the wind collecting unit 1, an increased wind velocity can be generated at the internal port (112a).

Further, the funnel-shaped wall 11 may be configured in the form of a telescopic or partly-detachable structure such that the inlet end 111 is movable relative to the internal-port end 112 in the lengthwise direction so as to adjust the length thereof and the dimension of the wind inlet (111a).

Further, pressure fans 15 are securely disposed in the distal region (11a) by means of fastening, such as screws so as to stagewise pressurize the inflow air in the air channel 10.

The funnel-shaped wall 11 has first uptake and re-entry ports 113, 114 which extend therethrough to communicate with the distal and proximate regions (11a, 11b), respectively. A primary re-entry conduit 43 is disposed in the proximate region (11b) downstream of the first re-entry port 114 and extends to terminate at a first nozzle end 431 which is located immediately upstream of the internal port (112a). A primary wind-stream accelerating unit 4 is disposed outwardly of the funnel-shaped wall 11 between the first uptake and re-entry ports 113, 114. The primary wind-stream accelerating unit 4 is in the form of a turbo blower 41 which has an intake mouth 42 connected with the first uptake port 113, and an outlet connected with the primary re-entry conduit 43. Thus, a first side stream of wind is taken up through the first uptake port 113 to speed up the velocity thereof such that a first accelerated side stream of wind is delivered out of the first nozzle end 431 to be entrained in the main stream so as to induce a negative pressure, thereby forming united streams with an increased velocity before dashing through the entry port 211 into a rotor receiving chamber 28 of the rotor unit 2. Preferably, the first nozzle end 431 has a sectional area which is half of that of the internal port (112a), and, as shown in FIG. 3, is rectangular in cross-section. More preferably, the first nozzle end 431 is tapered to further increase the wind velocity.

The rotor unit 2 includes a rotor housing 21 and a rotor 22. The rotor housing 21 has a surrounding wall which surrounds a rotary axis that is perpendicular to the lengthwise direction, and which defines the rotor receiving chamber 28. The surrounding wall is connected with the internal-port end 112, and has an entry port 211 in spatial communication with the internal port (112a) by virtue of a coupling duct 16 so as to permit entry of the united wind streams into the rotor receiving chamber 28. The rotor housing 21 further has a shutter 20 disposed to be angularly slidable relative to the entry port 211 so as to regulate the inflow rate of the united wind streams through the entry port 211. The rotor 22 includes a rotary shaft 221 which is rotatably mounted on the rotor housing 21 in the rotor receiving chamber 28 about the rotary axis, and a plurality of vanes 222 which extend radially from the rotary shaft 221 and which are angularly displaced from one another about the rotary axis. The generator 3 is disposed under the rotary unit 2, and is coupled with and driven by the rotary shaft 221 by virtue of an output shaft 25 extending in an upright direction.

Each of the vanes 222 has a leading vane face (222a) which confronts the united wind streams and is driven thereby so as to rotate the rotary shaft 221 about the rotary axis, and a trailing vane face (222b) which is opposite to the leading vane face (222a) and which is tapered in shape so as to reduce wind resistance of the rotor 22 during rotation.

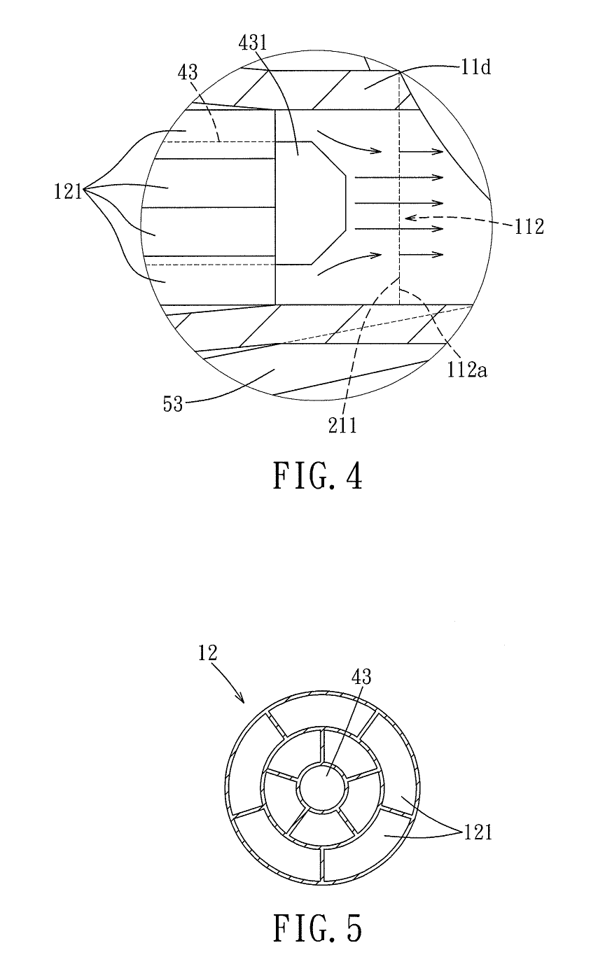

Accordingly, the incoming wind from the wind inlet (111a) is pressurized stagewise by the pressure fans 15, and part of the air stream (the first side stream of wind) is taken up through the first uptake port 113 to be sped up by the turbo blower 41 and delivered out of the first nozzle end 431. As shown in FIG. 4, the first accelerated side stream of wind is entrained in the main stream to induce a negative pressure, which facilitates incoming of ambient air through the wind inlet (111a). The wind power density, measured in watts per square meter, indicates how much energy is available at the site for conversion by a wind turbine, and is in proportional to the cube of the wind velocity. For example, as wind speed triples, the capacity of wind power converted with the generator increases almost twenty-sevenfold. Therefore, with the configuration of the funnel-shaped wall 11, the wind velocity of the main stream is greatly increased. Additionally, the first accelerated side stream of wind through the turbo blower 41 is entrained at the tubular zone (11d) to further speed up the wind velocity of the united stream to the rotor receiving chamber 28.

Preferably, referring to FIGS. 4 and 5, an airflow rectifying member 12 is disposed in the proximate region (11b) immediately upstream of the tubular zone (11d) and to divide the proximate region (11b) into a plurality of parallel straight passages 121 so as to direct the main stream in the lengthwise direction toward the internal port (112a), thereby minimizing airflow loss and velocity reduction. The airflow rectifying member 12 includes a plurality of rounded tubes extending coaxially and a plurality of partition plates interconnecting therebetween.

Preferably, as shown in FIG. 1, the funnel-shaped wall 11 further has a second uptake port 115 extending therethrough to communicate with the distal region (11a). A secondary re-entry conduit 53 is disposed outwardly of the funnel-shaped wall 11 and extends to terminate at a second nozzle end 531 which is located in the rotor receiving chamber 28 in a direction substantially tangential to the surrounding wall 21. A secondary wind-stream accelerating unit 5 is disposed outwardly of the funnel-shaped wall 11, and is in the form of a high-pressure turbo blower 51 which has an intake mouth 52 connected with the second uptake port 115, and an outlet connected with the secondary re-entry conduit 53. Thus, a second side stream of wind is taken up through the second uptake port 115 to speed up the velocity thereof such that a second accelerated side stream of wind is delivered out of the second nozzle end 531 into the rotor receiving chamber 28 in the tangential direction, thereby confronting and directly driving the vanes 222 for increasing kinetic energy of the rotary shaft 221. The second nozzle end 531 may be located at a vicinity of the entry port 211. Preferably, the second nozzle end 531 of the secondary re-entry conduit 53 is tapered to further increase the wind velocity flowing therethrough.

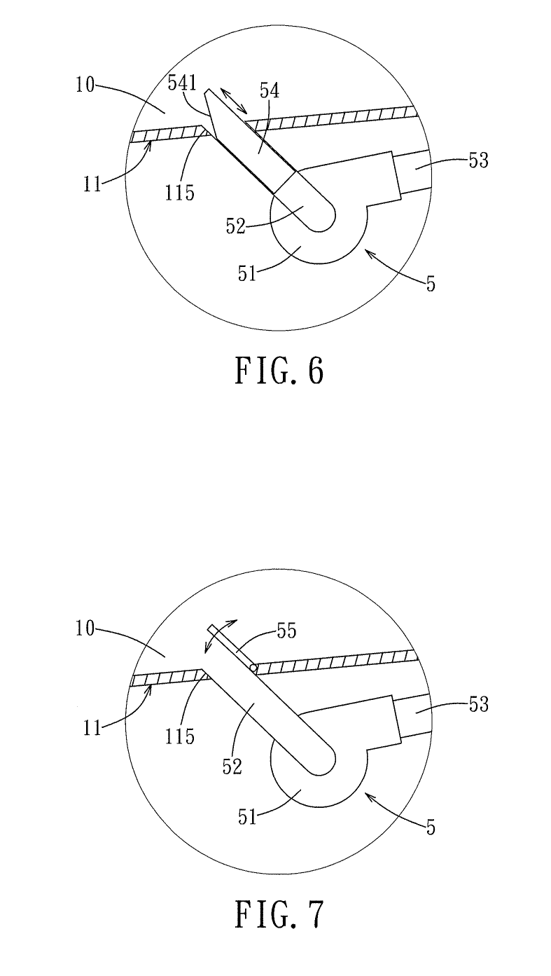

Referring to FIG. 6, an inflow regulating valve 54 is disposed to be slidable relative to the intake mouth 52 of the turbo blower 51 so as to be adjusted based on the velocity of the main stream such that the volumetric flow of the second side stream admitted through the second uptake port 115 is adjustable. The inflow regulating valve 54 is in the form of a tube insertable into the air channel 10 and having a taper opened end 541. Alternatively, referring to FIG. 7, the inflow regulating valve 55 may be in the form of a rotating plate pivotally mounted at the second uptake port 115.

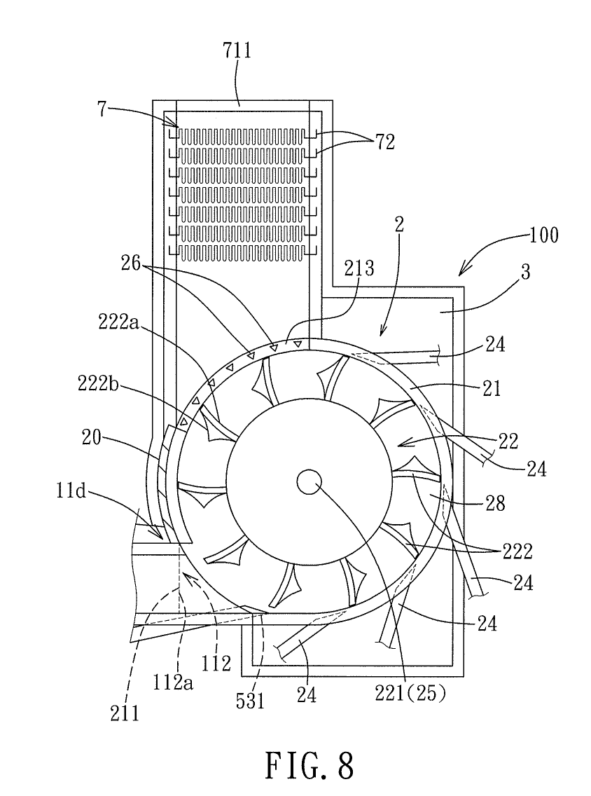

Referring to FIGS. 1 and 8, alternatively, a plurality of re-entry conduits 24 are disposed to extend into the rotor receiving chamber 28 in tangential directions, and are angularly displaced from one another about 15-30 degrees around half of the surrounding wall of the rotor housing 21. Alternatively, the re-entry conduits 24 may be arranged to be displaced from one another in the direction of the rotary axis. With the arrangement of the re-entry conduits 24 around the half of the surrounding wall (about 180 degrees), the moment of inertia of the rotor 22 is increased. Hence, the rotational kinetic energy of the rotor 22 may be increased.

The airflow introduced into the re-entry conduits 24 may be supplied by an air compressor or a blower such as that similar to the turbo blower 51. In other words, a plurality of secondary wind-stream accelerating units 5 may be provided in the wind turbine electricity generating device 100.

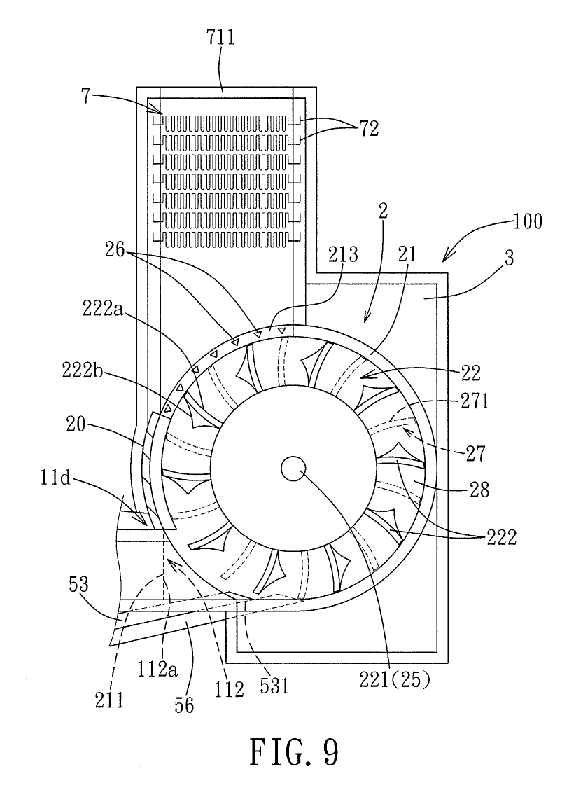

Referring to FIG. 9, alternatively, the rotor unit 2 may further include a pair of auxiliary fans 27 (only one is shown) such that the rotor 22 is coaxially disposed between the auxiliary fans 27. Each of the auxiliary fans 27 has a plurality of vanes 271. Furthermore, a fourth re-entry conduit 56 is disposed to be connected with the turbo blower 51 (see FIG. 1) and extends into the rotor receiving chamber 28 toward the vanes 271 of the auxiliary fans 27 so as to permit part of airflow through the turbo blower 51 to drive the auxiliary fans 27. Therefore, the outputting kinetic energy of the rotor unit 2 is further increased. The fourth re-entry conduit 56 may be in the form of a manifold of the secondary re-entry conduit 53.

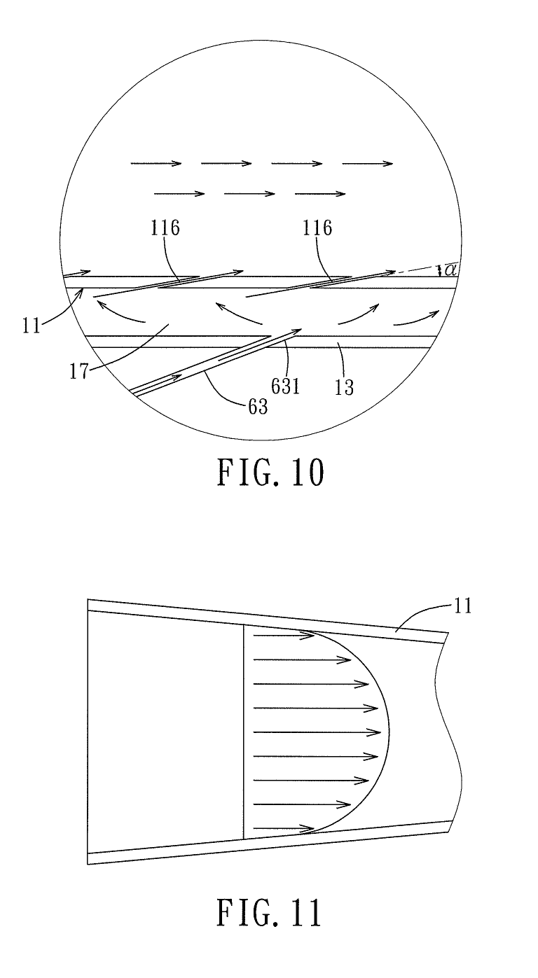

Referring to FIGS. 1, 10 and 11, preferably, the funnel-shaped wall 11 has a plurality of slits 116 extending therethrough and inclined relative thereto to permit entry of ambient air into the proximity of an inner wall surface of the funnel-shaped wall 11 so as to insulate the main stream from direct frictional contact with the inner wall surface of the funnel-shaped wall 11. In other words, by virtue of airflow through the slits 116, the velocity of the main stream in the proximity of the inner wall surface of the funnel-shaped wall 11 can be kept undeterred. The inclined angle (α) of each of the slits 116 relative to the funnel-shaped wall 11 is about less than 10 degrees.

Preferably, an outer shell 13 is disposed to surround the funnel-shaped wall 11 to cooperatively define a surrounding clearance 17 in spatial communication with the slits 116. The funnel-shaped wall 11 further has a third uptake port 117 extending therethrough to communicate with the proximate region (11b). A tertiary re-entry conduit 63 extends through the outer shell 13 to terminate at a third nozzle end 631 which is located in the surrounding clearance 17 upstream of the slits 116. A tertiary wind-stream accelerating unit 6 is disposed outwardly of the outer shell 13, and may be in the form of a middle-pressure turbo blower 61 which has a tubular intake mouth 62 connected with the third uptake port 117, and an outlet connected with the tertiary re-entry conduit 63. Thus, a third side stream of wind is taken up through the third uptake port 117 to speed up the velocity thereof such that a third accelerated side stream of wind is delivered out of the third nozzle end 631 into the surrounding clearance 17, thereby speed up the entry of ambient air into the proximity of the inner wall surface of the funnel-shaped wall 11. The third nozzle end 631 may be located at a position between the inlet end 111 and each of the first and second uptake ports 113, 115.

Alternatively, each of the turbo blowers 41, 51, 61 may be a high-pressure air compressor instead.

Referring to FIGS. 1 and 12, preferably, a gap reducing unit includes a plurality of gap reducing elements 23 disposed on the vanes 222 and extending toward an inner wall surface of the surrounding wall of the rotor housing 21 to minimize a gap therebetween so as to minimize airflow loss.

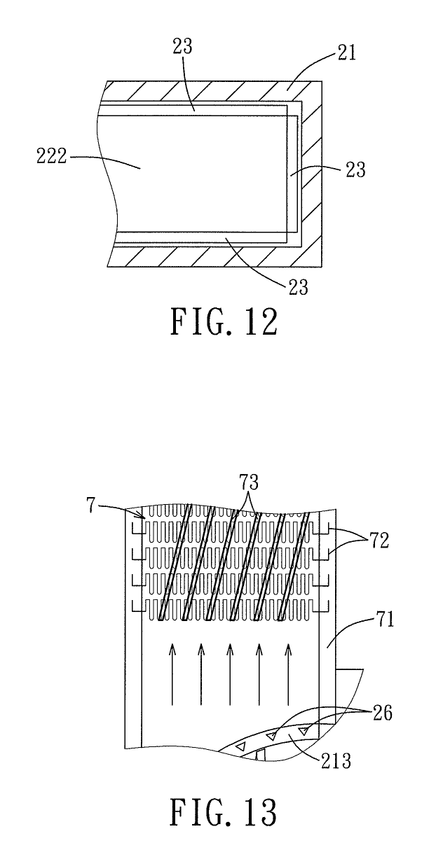

Referring to FIGS. 1, 8 and 13, preferably, a moisture removing unit 7 includes a heat exchanging housing 71 which is disposed downstream of the rotor receiving chamber 28, and a tubular heat exchanger 72 and a condenser 73 which are disposed in the heat exchanging housing 71 to cool and condense water vapor entrained in hot air flowing in the heat exchanging housing 71 from the rotor receiving chamber 28. Specifically, the rotor housing 21 has an opening 213 to communicate the heat exchanging housing 71, and a plurality of reinforcing ribs 26 disposed in the opening 213 and spaced apart from one another so as to reinforce the structure in the opening 213. Each of the reinforcing ribs 26 may be tapered so as to minimize resistance to the air flowing in the heat exchanging housing 71.

Moreover, the heat exchanging housing 71 has a vent port 711 for ventilation.

Preferably, the condenser 73 is in the form of a plurality of condenser plates which are tilted to face the airflow through the opening 213. When flowing in the heat exchanging housing 71, the air with reduced pressure absorbs ambient heat so as to dip the temperature inside the heat exchanging housing 71. A large amount of water vapor entrained in the hot air is condensed by the condenser 73 so as to drip down, filtered, and collected to become drinkable water. A vibrator or an air blade (not shown) may be used to remove the water vapor from the condenser 73.

Note that part of electric power generated by the generator 3 can be supplied to the re-entry conduits 24 and the tubular heat exchanger 72.

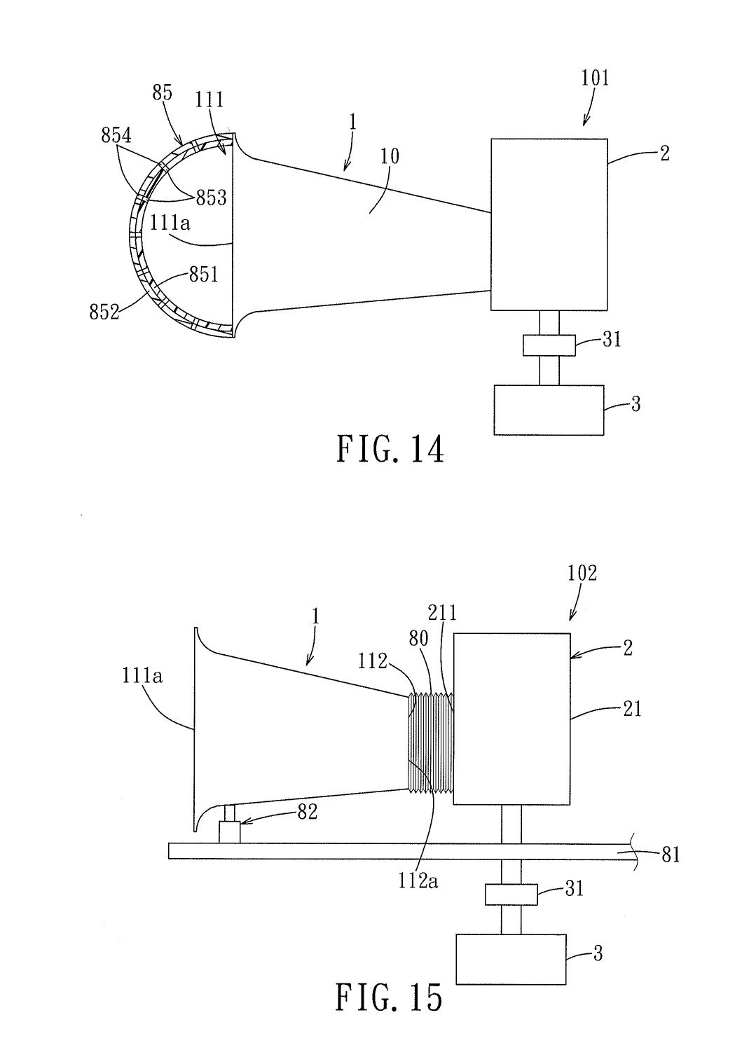

Referring to FIG. 14, the second embodiment of the wind turbine electricity generating apparatus according to this invention is similar to the first embodiment, and similarly comprises a wind turbine electricity generating device 101 which further includes a shield cover 85 disposed on the inlet end 111 to shield the wind inlet (111a). In this embodiment, the shield cover 85 includes inner and outer sheets 851, 852 which are movable (rotatable) relative to each other and which respectively have through holes 853, 854 for adjustment of the inflow rate of the incoming wind admitted into the air channel 10. During a very high wind condition, the shield cover 85 can minimize damage to the component parts disposed in the wind collecting unit 1. The shield cover 85 may be detachably mounted on the inlet end 111.

Additionally, in this embodiment, a universal joint 31 (or a clutch) is disposed to couple the rotor unit 2 and the generator 3 to permit rotation of the rotor unit 2 relative to the generator 3 such that an angular position of the wind inlet (111a) can be adjusted.

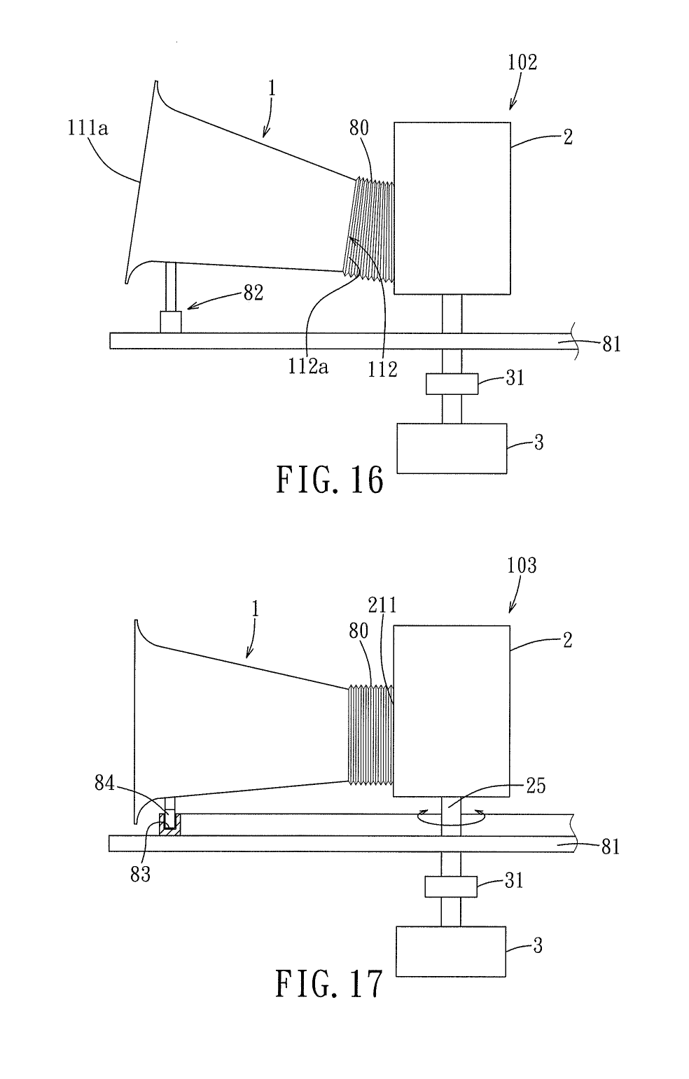

Referring to FIGS. 15 and 16, in the third embodiment of the wind turbine electricity generating apparatus of this invention, the device 102 further includes a platform 81 adapted to be mounted on a ground, an upright support 82 extending from the platform 81 to support the wind collecting unit 1, and a resiliently deformable tubular member 80 interconnecting the internal-port end 112 and the surrounding wall of the rotor housing 21 to permit the wind collecting unit 1 to turn relative to the rotor housing 21 so as to adjust an angular position of the wind inlet (111a). In this embodiment, the upright support 82 has a telescopic stem, such as a hydraulic cylinder, to permit the wind collecting unit 1 to be liftable so as to adjust a tilted position of the wind inlet (111a) at a desired angle.

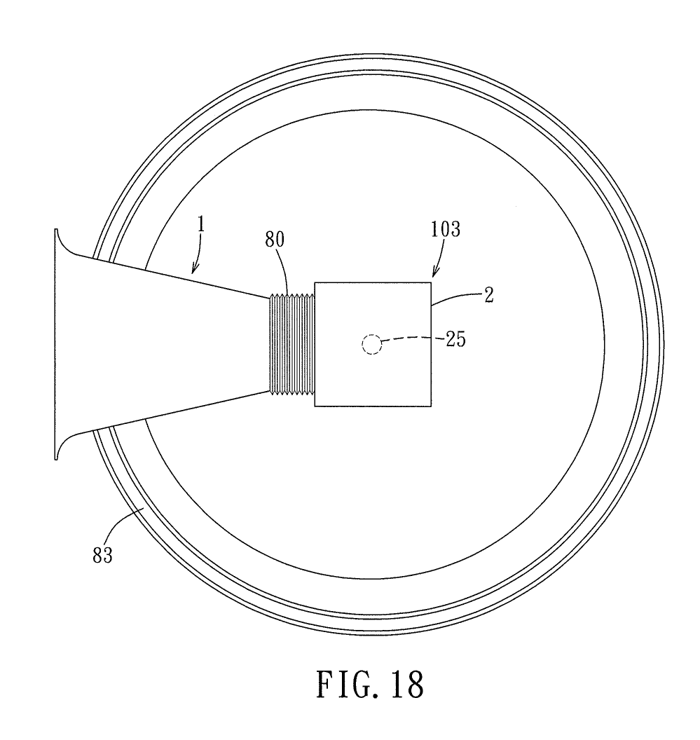

Referring to FIGS. 17 and 18, alternatively, in the fourth embodiment of the wind turbine electricity generating device 103, a support includes a circular guide rail 83 disposed on the platform 81 to surround the output shaft 25, and a roller 84 disposed on the wind collecting unit 1 to be slidable on the circular guide rail 83 so as to adjust the upwind direction of the wind inlet (111a) according to the wind conditions.

Furthermore, the funnel-shaped wall 11, the surrounding wall of the rotor housing 21, and the housing of the generator 3 may be made from metal covered with a plastic sheet 14 (see FIG. 1) so as to avoid electromagnetic interference, thereby functioning as a damper and a muffler for reducing noise.

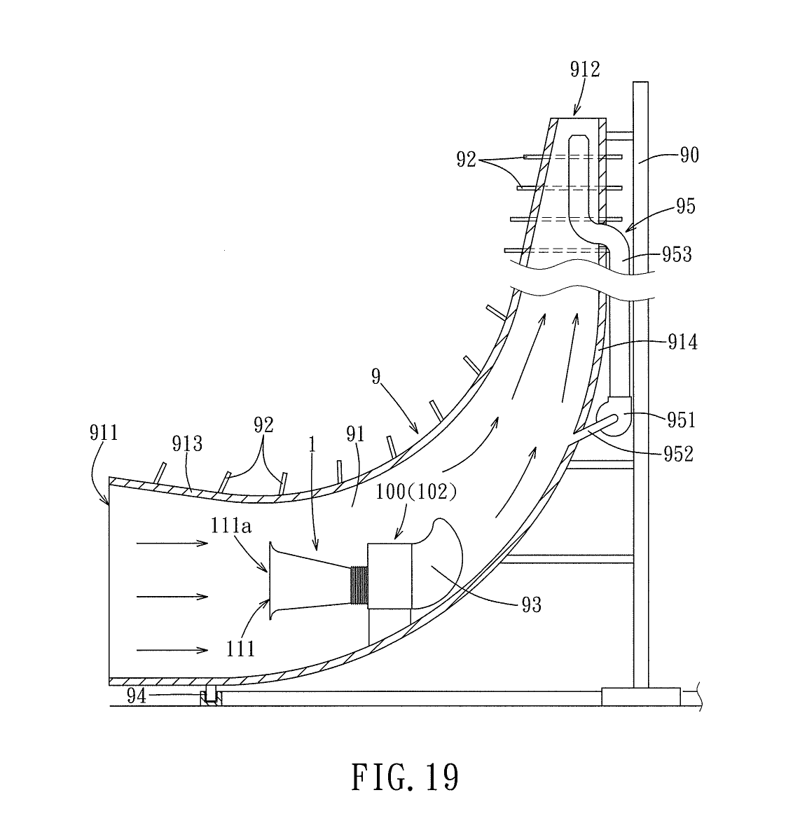

Referring to FIG. 19, the fifth embodiment of the wind turbine electricity generating apparatus according to this embodiment further comprises a wind duct 9 defining a wind channel 91 therein and having a large-diameter entering end 911 which extends in the lengthwise direction and a small-diameter exiting end 912 which extends in the upright direction such that the wind velocity at the exiting end 912 is much larger than that at the entering end 911. The wind channel 91 has a longitudinal wall segment 913 and an upright wall segment 914. The wind collecting unit 1 is received in the longitudinal wall segment 913 to have the inlet end 111 oriented coaxial with the large-diameter entering end 911. The outer wall surface of the wind channel 91 may be made from a heat absorbing material.

Further, a heat absorbing unit including a plurality of heat absorbing elements 92 is disposed on the wind duct 9 to warm the interior thereof. In this embodiment, each of the heat absorbing elements 92 may be of a plate made from a heat absorbing material, an electrically heating element used with a solar panel, or an artificially heating plate (such as heated by electric energy, gas, fuel, etc.). When the heat absorbing elements 92 absorb heat energy to raise the temperature of the wind channel 91, the wind velocity at the entering end 911 is increased to induce a pressure difference between the entering and exiting ends 911, 912 so as to pump air flowing toward the exiting end 912 (a stack effect). Thereby, larger amounts of incoming wind may enter the wind inlet (111a) to enhance the efficiency of electric generation.

Alternatively, instead of the heat absorbing elements 92, a plurality of heating elements (not shown) are disposed to heat the upright wall segment 914.

Further, a blower unit 95 is disposed outwardly of the upright wall segment 914, and includes a turbo blower 951 which has an intake mouth 952 communicated with the wind channel 91, and which is coupled with a conduit 953 that extends into the upright wall segment 914 toward the exiting end 912.

Furthermore, a guiding member 93 is disposed rearwardly of the wind collecting unit 1 and is configured to extend in an extending direction of the upright wall segment 914 so as to direct ventilation of the airflow to the upright wall segment 914.

Furthermore, a roller 94 is disposed on the longitudinal wall segment 913 to be slidable on a guide rail disposed on a ground surface so as to adjust the upwind direction of the entering end 911. Additionally, the upright wall segment 914 is supported by an upright wall 90.

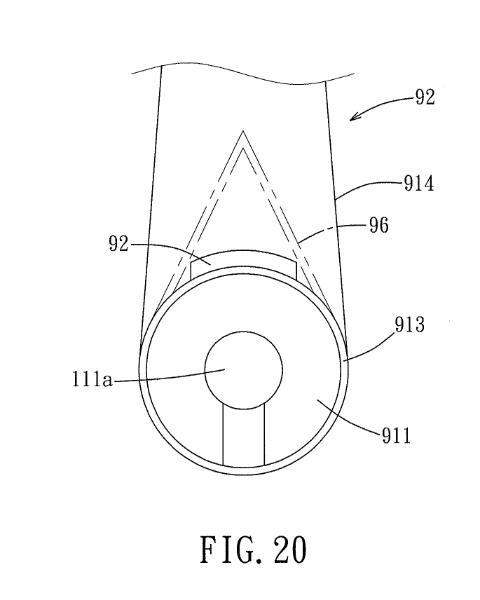

Referring to FIG. 20, in addition, an angled roof 96 is detachably mounted on the longitudinal wall segment 913 of the wind duct 9 to prevent snow pile-up. The angled roof 96 may be made from transparent plates to cover the heat absorbing elements 92 while not interfering heat absorbing of the solar panels mounted on the heat absorbing elements 92.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A wind turbine electricity generating apparatus comprising:
a wind collecting unit having an inlet end and an internal-port end which are opposite to each other in a lengthwise direction, and which respectively define a wind inlet and an internal port, and a funnel-shaped wall which extends between said inlet and internal-port ends and which defines an air channel for passage of a main stream of incoming wind from said wind inlet to said internal port, said air channel having distal and proximate regions relative to said internal port, and being configured to converge from said distal region toward said proximate region, said funnel-shaped wall having first uptake and re-entry ports which extend therethrough to communicate with said distal and proximate regions, respectively;
a rotor housing having a surrounding wall which surrounds a rotary axis that is perpendicular to the lengthwise direction, and which defines a rotor receiving chamber, said surrounding wall being connected with said internal-port end, and having an entry port in spatial communication with said internal port so as to permit entry of united wind streams into said rotor receiving chamber;
a rotor including a rotary shaft which is rotatably mounted on said rotor housing in said rotor receiving chamber about the rotary axis, and a plurality of vanes which extend radially from said rotary shaft and which are angularly displaced from one another about the rotary axis, each of said vanes having a leading vane face which confronts the united wind streams and is driven thereby so as to rotate said rotary shaft about the rotary axis;
a primary re-entry conduit disposed in said proximate region downstream of said first re-entry port and extending to terminate at a first nozzle end which is located immediately upstream of said internal port; and
a primary wind-stream accelerating unit disposed outwardly of said funnel-shaped wall between said first uptake and re-entry ports to speed up the velocity of a first side stream of wind taken up through said first uptake port such that a first accelerated side stream of wind is delivered out of said first nozzle end to be entrained in the main stream so as to induce a negative pressure, thereby forming the united stream with an increased velocity before dashing through said entry port into said rotor receiving chamber.

2. The wind turbine electricity generating apparatus as claimed in claim 1, wherein said wind collecting unit includes an airflow rectifying member disposed in said proximate region to direct the main stream in the lengthwise direction toward said internal port.

3. The wind turbine electricity generating apparatus as claimed in claim 2, wherein said proximate region of said funnel-shaped wall has a evenly dimensioned tubular zone which extends between said airflow rectifying member and said internal port.

4. The wind turbine electricity generating apparatus as claimed in claim 1, wherein said funnel-shaped wall further has a second uptake port extending therethrough to communicate with said distal region, and further comprising:
a secondary re-entry conduit disposed outwardly of said funnel-shaped wall and extending to terminate at a second nozzle end which is located in said rotor receiving chamber in a direction substantially tangential to said surrounding wall; and
a secondary wind-stream accelerating unit disposed outwardly of said funnel-shaped wall to couple said second uptake port with said secondary re-entry conduit to speed up the velocity of a second side stream of wind taken up through said second uptake port such that a second accelerated side stream of wind is delivered out of said second nozzle end into said rotor receiving chamber in the tangential direction.

5. The wind turbine electricity generating apparatus as claimed in claim 4, wherein each of said first and second nozzle ends of said primary and secondary re-entry conduits is tapered.

6. The wind turbine electricity generating apparatus as claimed in claim 4, wherein each of said primary and secondary wind-stream accelerating units is in form of a turbo blower which has an intake mouth connected with a corresponding one of said first and second uptake ports, and an outlet connected with a corresponding one of said primary and secondary re-entry conduits.

7. The wind turbine electricity generating apparatus as claimed in claim 4, further comprising an inflow regulating valve which is configured to be adjustable based on the velocity of the main stream such that the volumetric flow of the second side stream admitted through said second uptake port is adjustable.

8. The wind turbine electricity generating apparatus as claimed in claim 4, wherein said funnel-shaped wall has a plurality of slits extending therethrough and inclined relative thereto to permit entry of ambient air into the proximity of an inner wall surface of said funnel-shaped wall so as to insulate the main stream from direct frictional contact with said inner wall surface of said funnel-shaped wall.

9. The wind turbine electricity generating apparatus as claimed in claim 8, wherein said wind collecting unit further includes an outer shell surrounding said funnel-shaped wall to cooperatively define a surrounding clearance which is in spatial communication with said slits, said funnel-shaped wall further having a third uptake port extending therethrough to communicate with said proximate region, and further comprising:
a tertiary re-entry conduit extending through said outer shell to terminate at a third nozzle end which is located in said surrounding clearance upstream of said slits; and
a tertiary wind-stream accelerating unit disposed outwardly of said outer shell to speedup the velocity of a third side stream of wind taken up through said third uptake port such that a third accelerated side stream of wind is delivered out of said third nozzle end into said surrounding clearance to thereby speed up the entry of ambient air into the proximity of said inner wall surface of said funnel-shaped wall.

10. The wind turbine electricity generating apparatus as claimed in claim 8, further comprising a gap reducing unit disposed on said vanes and extending toward an inner wall surface of said surrounding wall to minimize a gap therebetween.

11. The wind turbine electricity generating apparatus as claimed in claim 1, wherein said funnel-shaped wall is configured to permit movement of said inlet end relative to said internal-port end in the lengthwise direction so as to adjust the length thereof and the dimension of said wind inlet.

12. The wind turbine electricity generating apparatus as claimed in claim 1, wherein said rotor housing further has a shutter disposed to be angularly slidable relative to said entry port to regulate the inflow rate of the united wind streams through said entry port.

13. The wind turbine electricity generating apparatus as claimed in claim 1, further comprising a moisture removing unit including a heat exchanging housing which is disposed downstream of said rotor receiving chamber, and a tubular heat exchanger and a condenser which are disposed in said heat exchanging housing to cool and condense water vapor entrained in hot air flowing in said heat exchanging housing from said rotor receiving chamber.

14. The wind turbine electricity generating apparatus as claimed in claim 1, further comprising a platform, an upright support extending from said platform to support said wind collecting unit, and a resiliently deformable tubular member interconnecting said internal-port end and said surrounding wall to permit said wind collecting unit to turn relative to said rotor housing so as to adjust an angular position of said wind inlet.

15. The wind turbine electricity generating apparatus as claimed in claim 14, wherein said upright support is configured to permit said wind collecting unit to be liftable so as to adjust a tilted position of said wind inlet at a desired angle.

16. The wind turbine electricity generating apparatus as claimed in claim 14, wherein said upright support including a circular guide rail disposed on said platform to surround said rotary shaft, and a roller disposed on said wind collecting unit to be slidable on said circular guide rail so as to adjust upwind direction of said wind inlet.

17. The wind turbine electricity generating apparatus as claimed in claim 1, further comprising a shield cover disposed on said inlet end to shield said wind inlet and having a plurality of through holes for adjustment of the inflow rate of the incoming wind admitted into said air channel.

18. The wind turbine electricity generating apparatus as claimed in claim 1, wherein each of said vanes has a trailing vane face opposite to said leading vane face and tapered in shape so as to reduce wind resistance of said rotor during rotation.

19. The wind turbine electricity generating apparatus as claimed in claim 1, further comprising a wind duct defining a wind channel therein and having a large-diameter entering end which extends in the lengthwise direction and a small-diameter exiting end which extends in an upright direction, said wind collecting unit being received in said wind channel to have said inlet end oriented coaxial with said large-diameter entering end.

20. The wind turbine electricity generating apparatus as claimed in claim 1, further comprising a heat absorbing unit disposed on said wind duct to warm the interior thereof.
